(19) United States
(12) Patent Application Publication
(10) Pub. No.: US 2018/0012317 A1
(43) Pub. Date: Jan. 11, 2018

(54) SYSTEMS AND METHODS FOR CONNECTING DISPARATE COMPUTING DEVICES VIA STANDARD INTERFACES

(71) Applicant: Alibaba Group Holding Limited, Grand Cayman (KY)

(72) Inventors: Yuzhou HUANG, Hangzhou (CN); Guanghua HU, Hangzhou (CN); Yanjun LI, Hangzhou (CN); Hua ZHOU, Hangzhou (CN); Jiangwei LUO, Hangzhou (CN); Lian WANG, Hangzhou (CN)

(21) Appl. No.: 15/640,750

(22) Filed: Jul. 3, 2017

(30) Foreign Application Priority Data
Jul. 6, 2016 (CN) 201610528250.1

(51) Int. Cl. G06Q 50/12; G06Q 20/40; G06Q 20/24

(52) U.S. Cl. CPC G06Q 50/12; G06Q 20/24; G06Q 20/40

(57) ABSTRACT

The disclosure relates to a hotel information processing system. In one embodiment, a method comprises receiving a notification sent by a hotel reservation server for verifying a hotel credit qualification of a user submitting a reservation request, the notification including identity information associated with the user; acquiring a credit score for a third-party account of the user based on the identity information; determining that the user is approved for the hotel credit qualification if the credit score meets a preset minimum credit score threshold; generating a booking for the user of a specified hotel room type included within the reservation request; and returning a verification result of the hotel credit qualification of the user to the hotel reservation server.

### CROSS-REFERENCE TO RELATED APPLICATIONS

This application claims the benefit of priority of Chinese Application No. 201610528250.1, titled “A System for Processing Hotel Information,” filed on Jul. 6, 2016, which is hereby incorporated by reference in its entirety.

### BACKGROUND

### Technical Field

The disclosure relates to the field of network interfaces and connectivity, and specifically to systems and methods for connecting disparate computing devices and networks via shared, standard interfaces.

### Description of the Related Art

With the rapid development of Internet technologies, a growing number of users enjoy reserving hotel rooms online, such as reserving hotel rooms using an Online Travel Agent (“OTA”) website. Online hotel reservations greatly facilitate users' reservations; therefore, an increasing number of OTA websites are emerging, which has led to intensified competition in the online travel industry.

Currently, the online travel industry is being restructured and is facing the increasingly severe problem of homogenization within the industry. Strengthening user services and reducing operational costs of a hotel and thereby improving the core competitiveness of an online reservation website (e.g., a hotel's official website or an OTA website) is an urgent issue each online reservation website seeks to address. However, conventional “online room reservation” techniques have the following problems.

1) Available Capital Affected by the Deposit

Current online hotel reservation service procedures generally include the following steps: a user prepays a room fee; the user makes an advance payment at a reception desk; the user checks out of the hotel; and the advance payment is returned after check out. A hotel may generally charge a fee higher than the room fee or use users' pre-authorized bank cards (e.g., credit/debit cards) for a deposit when processing the check-in of a user (e.g., at a reception desk). During a hotel stay, the room fee is deducted from the user's available capital twice or more. Therefore, this conventional method not only ties up a user's available capital, but it also leads to a complicated procedure. A more extreme case is when the room type requires users to prepay a full amount of the room fee when booking online.

2) User Experience Problem

When a user checks in at a hotel, the user needs to submit identity information to the hotel reception desk and pay a deposit (by swiping a card or using cash). A user also needs to wait in a long line if many guests are waiting at the same time. When the user checks out of the hotel, the user needs to return the room card, wait for the room check to verify any spending incurred during the user's stay, followed by other operations such as making payment with cash or canceling the pre-authorization of a credit card. In other words, a user needs to bring some cash or a credit card for check-in and needs to spend some time waiting during check-in and check-out.

3) Complex Operations at the Hotel Reception Desk

Hotel receptionists need to perform operations such as receiving room fees, receiving deposits, checking rooms, closing accounts, returning overcharges, and demanding payment of shortages. Therefore, the operations performed by the hotel reception desk are rather complex. The long times for performing these operations also lead to a longer waiting time for hotel guests.

These existing problems of the online hotel reservation systems pose significant difficulties in enhancing user experience, which in turn reduces an online reservation website's competitiveness. In view of the above, one problem found in current solutions is that a required deposit for a hotel stay reduces a user's available capital.

### BRIEF SUMMARY

To solve the aforementioned problems in current systems (e.g., that a deposit for a hotel stay reduces a user's available capital), the disclosure provides a hotel information processing system. The disclosure further provides a method, apparatus, and electronic device for reserving a hotel room; a method, apparatus, and electronic device for generating or managing bookings; and other hotel information processing systems.

In one embodiment, a method comprises receiving a notification sent by a hotel reservation server for verifying a hotel credit qualification of a user submitting a reservation request, the notification including identity information associated with the user; acquiring a credit score for a third-party account of the user based on the identity information; determining that the user is approved for the hotel credit qualification if the credit score meets a preset minimum credit score threshold; generating a booking for the user of a specified hotel room type included within the reservation request; and returning a verification result of the hotel credit qualification of the user to the hotel reservation server.

In another embodiment, an apparatus comprises a processor and a non-transitory memory storing computer-executable instructions therein that, when executed by the processor, cause the apparatus to perform the operations of receiving a notification sent by a hotel reservation server for verifying a hotel credit qualification of a user submitting a reservation request, the notification including identity information associated with the user; acquiring a credit score for a third-party account of the user based on the identity information; determining that the user is approved for the hotel credit qualification if the credit score meets a preset minimum credit score threshold; generating a booking for the user of a specified hotel room type included within the reservation request; and returning a verification result of the hotel credit qualification of the user to the hotel reservation server.

Compared with current systems, the hotel information processing system provided in the disclosed embodiments includes a hotel reservation subsystem, a first management subsystem, and a third-party subsystem. After receiving a reservation request for a specified room type sent by a client device of a user, the hotel reservation subsystem sends a first notification verifying a hotel credit qualification of the user to the first management subsystem based on the reservation request. After receiving the first notification sent by the hotel reservation subsystem, the first management subsystem acquires a credit score for a third-party account of the user based on identity information of the user included in the first notification; determines that the user is approved via verification of the hotel credit qualification if the credit score meets a preset minimum credit score threshold; generates a second booking of the specified hotel room type for the user; and returns a verification result of the hotel credit qualification of the user to the hotel reservation subsystem. After receiving the verification result of the hotel credit qualification of the user returned by the first management subsystem, the hotel reservation subsystem generates a first booking of the specified room type for the user based on the reservation request if the verification result of the hotel credit qualification is positive. After receiving a second notification to transfer resources for the first booking sent by the hotel, the first management subsystem acquires the second booking associated with the first booking based on the second notification; and the first management subsystem sends a third notification to transfer resources for the second booking to the third-party subsystem. After receiving the third notification sent by the first management subsystem, the third-party subsystem removes resources from the third-party account based on the third notification, and transfers the removed resources to a third-party account of the hotel.

With the hotel information processing system provided in the disclosed embodiments, a hotel reservation subsystem deployed as part of or as an official website of a hotel can verify a hotel credit qualification of a third-party account of a user via a first management subsystem before generating a booking of a hotel room type for the user making a reservation. The hotel reservation subsystem generates the booking only when the third-party account of the user succeeds in the verification of the hotel credit qualification. Moreover, resource removal of the booking is implemented by the first management subsystem notifying the third-party subsystem of removing resources from the third-party account of the user after the user checks out of the hotel. In this way, a user is not required to prepay a deposit for a reserved hotel room. Therefore, the hotel information processing system provided in the disclosed embodiments can effectively improve users' experiences when staying at a hotel.

### BRIEF DESCRIPTION OF THE DRAWINGS

FIG. 1 is a block diagram illustrating a hotel information processing system according to some embodiments of the disclosure.

FIG. 2 is a flow diagram illustrating a hotel reservation method according to some embodiments of the disclosure.

FIG. 3 is a block diagram illustrating a hotel reservation apparatus according to some embodiments of the disclosure.

FIG. 4 is a block diagram illustrating an electronic device according to some embodiments of the disclosure.

FIG. 5 is a flow diagram illustrating a booking management method according to some embodiments of the disclosure.

FIG. 6 is a block diagram illustrating a booking management apparatus according to some embodiments of the disclosure.

FIG. 7 is a block diagram illustrating an electronic device according to some embodiments of the disclosure.

FIG. 8 is a block diagram illustrating a hotel information processing system according to some embodiments of the disclosure.

FIG. 9 is a block diagram illustrating a hotel information processing system according to some embodiments of the disclosure.

FIG. 10 is a flow diagram illustrating a hotel reservation method according to some embodiments of the disclosure.

FIG. 11 is a block diagram illustrating a hotel reservation apparatus according to some embodiments of the disclosure.

FIG. 12 is a block diagram illustrating an electronic device according to some embodiments of the disclosure.

FIG. 13 is a flow diagram illustrating a booking generation method according to some embodiments of the disclosure.

FIG. 14 is a block diagram illustrating a booking generation apparatus according to some embodiments of the disclosure.

FIG. 15 is a block diagram illustrating an electronic device according to some embodiments of the disclosure.

FIG. 16 is a block diagram illustrating a hotel information processing system according to some embodiments of the disclosure.

### DETAILED DESCRIPTION

Many specific details are described in the following disclosure to facilitate the understanding of the disclosed embodiments. However, the disclosed embodiments can be implemented in many other ways different from what is exactly described herein. Those skilled in the art can make modifications to the disclosed embodiments without departing from the scope of the disclosed embodiments. Therefore, the disclosed embodiments are not limited to the following disclosed specific embodiments.

The disclosed embodiments provide a hotel information processing system, a method, apparatus, and electronic device for reserving a hotel; a method, apparatus, and electronic device for generating or managing bookings; and various other hotel information processing systems. Detailed descriptions thereof will be given in the following embodiments.

The overall operation of the hotel information processing system provided in the disclosure is as follows: before generating a booking of a hotel room type for a user, the hotel reservation subsystem verifies a hotel credit qualification of a third-party account of the user via the first management subsystem. The hotel reservation subsystem generates the booking only when the third-party account of the user succeeds in the verification of the hotel credit qualification. Moreover, resource removal for the booking is implemented by the first management subsystem notifying the third-party subsystem of removing resources from the third-party account of the user after the user checks out of the hotel. The user can directly make a hotel reservation, check-in, and make payments without the need of prepaying a deposit for a reserved hotel room. Therefore, the user's hotel staying experience may be effectively improved.

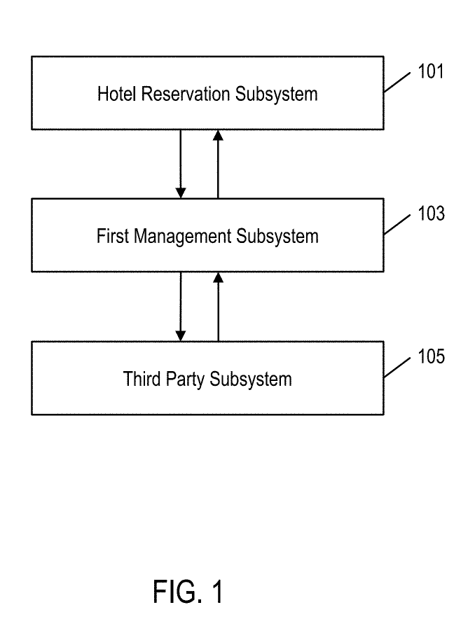

FIG. 1 is a block diagram illustrating a hotel information processing system according to some embodiments of the disclosure. The system includes the following subsystems: a hotel reservation subsystem 101, a first management subsystem 103, and a third-party subsystem 105.

In the illustrated embodiment, the hotel reservation subsystem 101 receives a reservation request for a specified room type sent by a client device of a user (not illustrated); sends a first notification for verifying a hotel credit qualification of the user to the first management subsystem 103 based on the reservation request; receives a verification result of the hotel credit qualification of the user returned by the first management subsystem 103; and generates a first booking of the specified room type for the user based on the reservation request if the verification result of the hotel credit qualification is positive.

The client device of the user may comprise a mobile communication device such as a smart phone, or may also comprise a terminal device such as a personal computer, a personal digital assistant, or a tablet (e.g., an IPAD).

The hotel reservation subsystem 101 implements an online hotel reservation function, and is generally deployed at a server of an official website of the hotel. However, it is not limited to be deployed at a server; any device that can execute the hotel reservation subsystem 101 described herein can be used.

In one embodiment, the user may first use the client device to open a hotel query interface provided by the hotel reservation subsystem 101 to view a variety of room types provided by the hotel. The user may then click a room type of interest to view the room's details. After the user decides to reserve a room type, the user may further log into the hotel reservation subsystem 101 with a registered username. The hotel reservation subsystem 101 can then acquire personal information of the user (e.g. a name, mobile phone number, and identity card number) by searching with the username. When the user intends to reserve a room type, and if the room type can be reserved using a credit-based method, the user may select a credit payment method with the client device of the user and submit a reservation request. The reservation request is sent to the hotel reservation subsystem 101 via a network (e.g., the Internet). After the hotel reservation subsystem 101 receives the reservation request sent by the client device of the user, the hotel reservation subsystem 101 will send a first notification to verify a hotel credit qualification of the user to the first management subsystem 103. This is because the reservation in this case is made using a credit method and a credit management function is implemented by a party (e.g. an OTA website) where the first management subsystem 103 is installed or located. The first notification includes identity information of the user, wherein the identity information of the user may either be obtained by querying with the username as discussed previously, or by the input from the client device of the user. After the hotel reservation subsystem 101 receives a verification result of the hotel credit qualification of the user returned by the first management subsystem 103 in response to the first notification, if the verification result is positive, the hotel reservation subsystem 101 will generate a hotel booking of the room type for the user making the reservation (i.e. the first booking).

The first booking is stored at the hotel reservation server. A management system of the hotel will proceed with check-in of the user according to the first booking when the user checks in at the hotel by using a number associated with the booking, the identity card number of the user, the mobile phone number, or other information. Because the hotel stay is reserved using a credit method, the user does not need to prepay a reservation deposit or a check-in deposit, thereby solving the problem existing in the conventional online hotel reservation method that a deposit reduces a user's available capital. Meanwhile, the operations of a hotel reception desk are simplified, accelerating the speed of processing the check-ins, thereby achieving the goal of improving the user experience.

In the illustrated embodiment, the first management subsystem 103 receives the first notification sent by the hotel reservation subsystem 101; acquires a credit score for a third-party account of the user based on identity information of the user included in the first notification; determines that the user is approved via the verification of the hotel credit qualification if the credit score meets a preset minimum credit score threshold, and generates a second booking of the specified hotel room type for the user, the second booking being used as a credential by the first management subsystem 103 for managing resource transfer for the first booking; returns the verification result of the hotel credit qualification of the user to the hotel reservation subsystem 101; receives a second notification to transfer resources for the first booking sent by the hotel; acquires the second booking associated with the first booking based on the second notification; and sends a third notification to transfer resources for the second booking to the third-party subsystem 105.

The first management subsystem 103 is generally deployed at a server of an OTA website. However, in other embodiments, the first management subsystem 103 it is not limited to being deployed at the server of the OTA web site and any device that can execute the first management subsystem 103 described herein can be used.

The identity information of the user refers to identity information that can be used to uniquely identify the identity of the user. The identity information of the user includes, but is not limited to, information of the user such as a mobile phone number, an identity card number, and a bank account.

The first management subsystem 103 implements functions such as verifying the hotel credit qualification of the user and managing the second booking. The system focuses on verifying the hotel credit qualification of the user based on a credit score for the third-party account (e.g. a third-party payment account such as ALIPAY) of the user, and determines that the user is approved via verification of the hotel credit qualification if the credit score meets a preset minimum credit score threshold. Meanwhile, the second booking will need to be generated.

The second booking is used as a credential for the first management subsystem to manage resource transfer for the first booking. That is, after the first management subsystem 103 receives a notification to transfer resources for the first booking sent by the hotel, the first management subsystem 103 will notify the third-party subsystem to transfer resources to the second booking.

It should be noted that this system manages and controls resource transfer (such as payment or collateral) of the third-party account of the user via the first management subsystem 103 so that an automatic resource transfer function for the first booking (the hotel booking) may be implemented. That is, verifying the hotel credit qualification of the user means verifying the hotel credit qualification of the third-party account of the user.

The credit score for the third-party account is generally a certain credit limit granted to the user (the third-party account) by a third-party credit platform based on information of the user, such as historical spending behaviors. Within the credit limit, a user can spend first before the resource is transferred. This also means that the third-party platform (e.g. a third-party payment platform) provides a guarantee for the user, and ensures that the spending of the user will be within the limit.

The credit score for the third-party account is generated by the third-party credit platform based on a user's personal information that affects the credit score. The personal information that affects the credit score includes, but is not limited to, at least one piece of the following personal information: credit history, spending preference, ability to make payments on time, identity, and personal connections.

The third-party credit platform may analyze and evaluate a personal credit score based on many data points; a higher evaluated score means a higher credit level; and a credit score is acquired after processing and calculating personal user information.

In one embodiment, the first management subsystem 103 further needs to acquire the third-party account of the user before acquiring the credit score for the third-party account of the user. The third-party account of the user may be acquired in two manners: 1) the first management subsystem 103 forwards a preset user login page of the third-party platform to the client device of the user; the user inputs a third-party account thereof through the login page; and the first management subsystem 103 can indirectly obtain the third-party account; and 2) the first management subsystem 103 directly queries a database thereof to obtain the third-party account of the user based on the identity information of the user. After acquiring the third-party account of the user, the first management subsystem 103 further acquires a credit score for the third-party account, followed by the subsequent step of verifying the hotel credit qualification.

Acquiring the credit score for the third-party account of the user may be implemented in two ways: 1) acquiring the credit score by using the third-party platform (e.g. a third-party payment platform such as ALIPAY); and 2) acquiring the credit score by using the third-party credit platform. These two ways of acquiring a credit score are described in more detail below.

1) Acquire the Credit Score by Using the Third-Party Platform

Acquiring a credit score by using the third-party platform may include the following steps: 1.1) sending a credit score query request for the third-party account of the user to the third-party subsystem 105; and 1.2) receiving a credit score for the third-party account of the user returned by the third-party subsystem 105.

Accordingly, the third-party subsystem 105 is further configured to receive the credit score query request sent by the first management subsystem 103; acquire the credit score for the third-party account of the user according to the first credit score query request; and return the credit score for the third-party account of the user to the first management subsystem 103.

2) Acquire the Credit Score by Using the Third-Party Credit Platform

When acquiring the credit score by using the third-party credit platform, the system further includes a credit evaluation subsystem, which runs in the third-party credit platform. The credit evaluation subsystem is configured to receive the credit score query request sent by the first management subsystem 103; query a pre-generated credit database for a credit score for the third-party account of the user; and return the queried credit score for the third-party account of the user to the first management subsystem 103.

The first management subsystem 103 acquiring the credit score by using the third-party credit platform may include the following steps: 2.1) sending a credit score query request for the third-party account of the user to the credit evaluation subsystem; and 2.2) receiving a credit score for the third-party account of the user returned by the credit evaluation subsystem.

The preset minimum credit score threshold may either be determined based on histories or determined based on the price of the specified room type. For example, the minimum credit score threshold may be set as a unified score. If the credit score is higher than the score, the user can enjoy credit services such as deposit-free reservation and check-in before payment. If the price of the reserved room type is high, the minimum credit score threshold may be set based on the price of the specific, requested room.

The second booking is stored at a server of the party where the first management subsystem 103 is set up (e.g. the OTA website). The second booking includes information such as information of the third-party account of the user and a booking number associated with the first booking. After receiving a resource transfer notification of the first booking sent by the hotel, the first management subsystem 103 notifies, according to the second booking associated with the first booking, the third-party subsystem 105 of transferring resources for actual spending in the hotel (such as payment of the stay) from the third-party account associated with the second booking.

To prevent the user from transferring resources for the first booking by using an unrelated third-party account, in one embodiment, the first management subsystem 103 is further configured to forward to the client device of the user a password verification page of a third-party platform affiliated with the third-party account. The third-party platform verifies a password of the third-party account based on the password of the third-party account provided by the user; and receives a verification result of the password of the third-party account returned by the third-party platform. It is determined that the user is approved via the verification of the hotel credit qualification if the verification result is positive. The second booking is generated only when it is determined that the user is approved via the verification of the hotel credit qualification. It is determined that the user is not approved via the verification of the hotel credit qualification when the verification result is negative. The verification result of the hotel credit qualification of the user is then returned to the hotel reservation subsystem 101. The password of the third-party account may be checked by using the above processing, thereby ensuring the security of using the third-party account.

Moreover, to avoid disputes between the user and the third-party platform, the third-party platform must ensure that the user clearly understands that the third-party platform may automatically remove resources from the third-party account. Therefore, the third-party platform needs to obtain the authorization of automatic resource removal from the user beforehand. Therefore, in some embodiments, the first management subsystem 103 is further configured to send a booking processing privilege query request for the third-party account to the third-party subsystem 105; receive a booking processing privilege of the third-party account returned by the third-party subsystem 105; and determine that the user is approved in the verification of the hotel credit qualification if the booking processing privilege is allowed. Likewise, the second booking is generated only when it is determined that the user is approved via the verification of the hotel credit qualification. It is determined that the user is not approved via the verification of the hotel credit qualification if the booking processing privilege is prohibited; and the verification result of the hotel credit qualification of the user is returned to the hotel reservation subsystem 101.

The booking processing privilege refers to a privilege clearly set by the user on whether the third-party platform is allowed to automatically remove resources from the third-party account.

Correspondingly, the third-party subsystem 105 is further configured to receive the booking processing privilege query request sent by the first management subsystem 103; acquire the booking processing privilege of the third-party account based on the booking processing privilege query request; and return the booking processing privilege of the third-party account to the first management subsystem 103.

In one embodiment, if the user is a new user of a hotel credit service, the booking processing privilege of the third-party account thereof is normally not set up yet. In this case, the first management subsystem 103 is further configured to forward a booking processing privilege setting page of the third-party platform to the client device of the user; receive an authorization result of the third-party account returned by the third-party platform; and determine that the user is approved in the verification of the hotel credit qualification if the authorization result is positive. It is determined that the user is not approved via the verification of the hotel credit qualification if the authorization result is inhibited; and the verification result of the hotel credit qualification of the user is returned to the hotel reservation subsystem 101.

The third-party subsystem 105 is configured to receive the third notification sent by the first management subsystem 103; remove resources from the third-party account based on the third notification; and transfer the removed resources to a third-party account of the hotel.

The third-party subsystem 105 is generally deployed at a server of the third-party platform; however, it is not limited to be deployed at this server, and any device that can execute the third-party subsystem 105 described herein can be used.

In one embodiment, after receiving a resource transfer success message returned by the third-party subsystem 105, the first management subsystem 103 further needs to update the state of the second booking to a completed state. The first management subsystem 103 then sends to the hotel reservation subsystem 101 a notification that the resources have been transferred for the first booking successfully.

In this embodiment, this system further includes a hotel management subsystem. The hotel management subsystem is configured to receive the first booking generated by the hotel reservation subsystem 101, the first booking being used as a credential for check-in of the user; receive a resource transfer request for the first booking sent by a client device of the hotel; and send a resource transfer notification to the first management subsystem 103 based on resource transfer information included in the resource transfer request.

The client device of the hotel may be deployed in a personal computer at the hotel reception desk, and may be connected to the hotel management subsystem through a network (e.g., a local area network or wide area network). When a user checks out at the hotel reception desk when their hotel stay ends, a hotel receptionist processes the user's payment by using the personal computer with the client device of the hotel. The client device of the hotel sends a resource transfer request corresponding to the first booking of the user to the hotel management subsystem. The hotel management subsystem sends a resource transfer notification to the first management subsystem 103 based on resource transfer information (which may include the first booking number, an actual spending amount, and the like) included in the resource transfer request. After receiving the resource transfer notification, the first management subsystem 103 will acquire the second booking associated with the first booking and then send a notification to transfer resources for the second booking to the third-party subsystem 105. After receiving the notification sent by the first management subsystem 103, the third-party subsystem 105 removes resources from the third-party account based on the notification, and transfers the removed resources to the third-party account of the hotel.

In another embodiment, the hotel management subsystem is further configured to receive a check-in request for the first booking sent by the client device of the hotel and update a booking state of the first booking to a check-in state. After updating the booking state of the first booking to the check-in state, the hotel management subsystem may further send to the first management subsystem 103 a notification that the user of the first booking has been checked in. The first management subsystem 103 updates a booking state of the second booking to a check-in state based on the notification. Therefore, it is ensured that the booking states of the first booking and the second booking are consistent with each other, facilitating the management of the bookings by the first management subsystem 103.

The credit score for the third-party account is a certain credit limit granted to the user by the third-party credit platform. Within the credit limit, a user can spend first before the resource is transferred. A certain amount of credit has indeed been used after the first booking is generated. This embodiment shows a solution wherein the credit evaluation subsystem is further configured to deduct the credit score accordingly for the third-party account based on the price of the specified room type after the second booking is generated and restore the credit score for the third-party account accordingly based on the price of the specified room type after the second booking is completed successfully. With the processing above, it is ensured that the user's spending will be within the limit.

For the hotel information processing system provided in the above embodiments, a hotel reservation subsystem 101 deployed as part of an official website of a hotel verifies a hotel credit qualification of a third-party account of a user via a first management subsystem 103 before generating a booking of the hotel room type for the user. The hotel reservation subsystem 101 generates the booking only when the third-party account of the user succeeds in the verification of the hotel credit qualification. Moreover, resource removal for the booking is implemented by the first management subsystem 103 notifying the third-party subsystem 105 of removing resources from the third-party account of the user after the user checks out of the hotel. In this manner, a user is not required to prepay a deposit for a reserved hotel room. Therefore, the hotel information processing system provided in the disclosure can effectively improve users' hotel staying experiences, thereby improving a hotel's market competitiveness.

A hotel information processing system is provided in the above embodiments. Correspondingly, the disclosed embodiments further provide a hotel reservation method, which runs in the hotel reservation subsystem in the above system. The method corresponds to the embodiment of the hotel reservation subsystem in the above system.

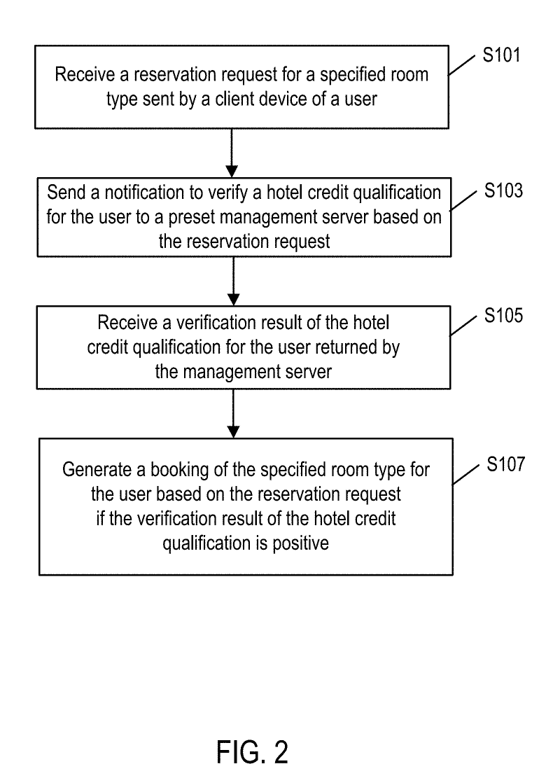

FIG. 2 is a flow diagram illustrating a hotel reservation method according to some embodiments of the disclosure. The embodiment disclosed in FIG. 2 is similar to the steps described in connection with the system embodiments discussed in connection with FIG. 1. Therefore, the description of FIG. 2 does not repeat all embodiments disclosed in connection FIG. 1 and reference can be made to the relevant of the description provided in connection with FIG. 1.

The hotel reservation method of illustrated in FIG. 2 includes the following steps.

Step S101: receive a reservation request for a specified room type sent by a client device of a user.

Step S103: send a notification to verify a hotel credit qualification for the user to a preset management server based on the reservation request, the notification including identity information of the user.

Step S105: receive a verification result of the hotel credit qualification for the user returned by the management server.

Step S107: generate a booking of the specified room type for the user based on the reservation request if the verification result of the hotel credit qualification is positive.

A hotel reservation method is provided in the above embodiment. Correspondingly, the disclosure further provides a hotel reservation apparatus. In one embodiment, the apparatus performs the operations described in connection with FIG. 2.

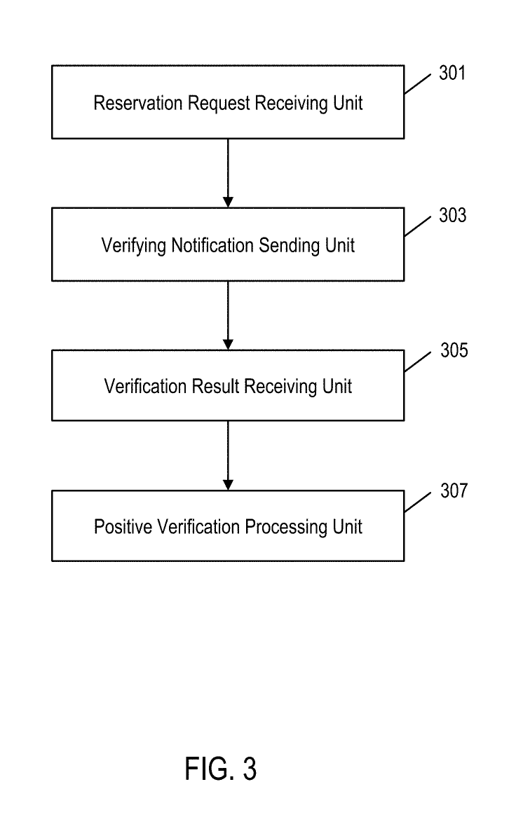

FIG. 3 is a block diagram illustrating a hotel reservation apparatus according to some embodiments of the disclosure. The embodiment of FIG. 3 performs operations similar to the methods described in connection with FIG. 2; therefore, the description of FIG. 3 is relatively concise. Reference can be made for the relevant parts of FIG. 3 by referring to the description provided in connection with FIG. 2.

A hotel reservation apparatus illustrated in FIG. 3 includes the following units.

A reservation request receiving unit 301, configured to receive a reservation request for a specified room type sent by a client device of a user.

A verifying notification sending unit 303, configured to send a notification to verify a hotel credit qualification of the user to a preset management server based on the reservation request, the notification including identity information of the user.

A verification result receiving unit 305, configured to receive a verification result of the hotel credit qualification for the user returned by the management server.

A verification success processing unit 307, configured to generate a booking of the specified room type for the user based on the reservation request if the verification result of the hotel credit qualification is positive.

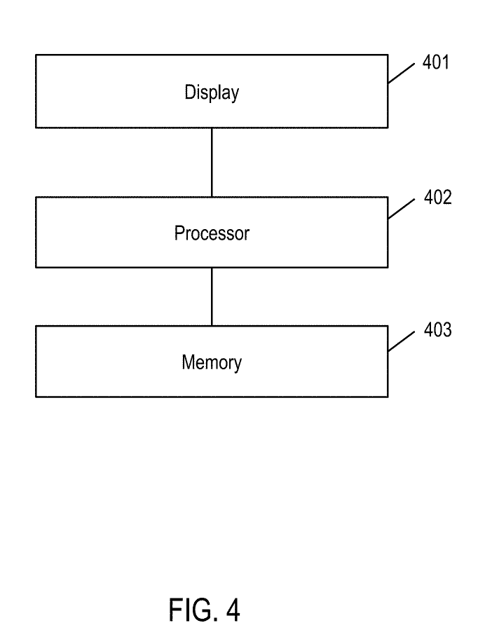

FIG. 4 is a block diagram illustrating an electronic device according to some embodiments of the disclosure. The processes performed by the electronic device depicted in FIG. 4 are similar to the method embodiments discussed in connection with FIG. 2, therefore, the description is relatively concise. Reference can be made for the relevant parts of the device illustrated in FIG. 4 by referring to the description of the steps described in connection with FIG. 2.

An electronic device is provided in the embodiment illustrated in FIG. 4. The electronic device includes: a display 401, a processor 402, and a memory 403. The memory 403 is configured store a program for implementing a hotel reservation method, and after the device is powered on and runs the program of the hotel reservation method via the processor 402, the following steps are performed: receiving a reservation request for a specified room type sent by a client device of a user; sending a notification to verify a hotel credit qualification of the user to a management server based on the reservation request, the notification including identity information of the user; receiving a verification result of the hotel credit qualification of the user returned by the management server; and generating a booking of the specified room type for the user based on the reservation request if the verification result of the hotel credit qualification is positive.

In accordance with the above hotel information processing system, the disclosure further provides a booking management method, which runs in the first management subsystem in the above system.

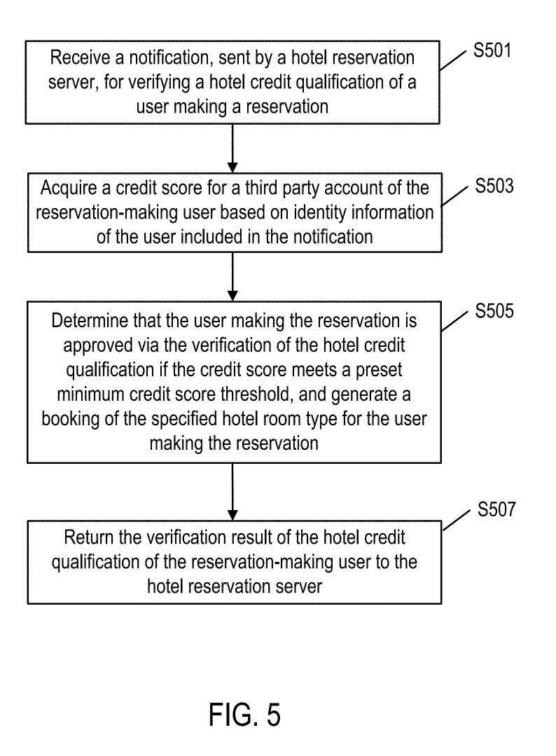

FIG. 5 is a flow diagram illustrating a booking management method according to some embodiments of the disclosure. The embodiment illustrated in FIG. 5 includes steps that are similar to those discussed in connection with FIG. 2, the disclosure of which is not repeated herein. Reference may be made by referring to the corresponding parts of the embodiment illustrated in FIG. 2. A booking management method provided in FIG. 5 includes the following steps.

Step S501: receive a notification, sent by a hotel reservation server, for verifying a hotel credit qualification of a user making a reservation.

In one embodiment, after the receiving a notification, sent by a hotel reservation server, for verifying a hotel credit qualification of a user making the reservation, the method further includes: setting a minimum credit score threshold based on the price of the specified room type included in the notification.

Step S503: acquire a credit score for a third-party account of the user making the reservation based on identity information of the user included in the notification.

In one embodiment, this step may include the following sub-steps: 1) sending a credit score query request for the third-party account to a third-party platform; and 2) receiving a credit score for the third-party account returned by the third-party platform.

Step S505: determine that the user making the reservation is approved via the verification of the hotel credit qualification if the credit score meets a preset minimum credit score threshold, and generate a booking of the specified hotel room type for the user making the reservation.

In one embodiment, before generating a booking of the specified hotel room type for the user making the reservation, the method further includes: 1) forwarding to a client device of the user making the reservation a password verification page of the third-party platform, the third-party platform verifying a password of the third-party account based on the password of the third-party account provided by the user making the reservation; 2) receiving a verification result of the password of the third-party account returned by the third-party platform; and 3) determining that the user making the reservation is not approved via the verification of the hotel credit qualification if the verification result is negative.

In one embodiment, before generating a booking of the specified hotel room type for the user making the reservation, the method further includes: 1) sending a booking processing privilege query request for the third-party account to the third-party platform; 2) receiving a booking processing privilege of the third-party account returned by the third-party platform; and 3) determining that the user making the reservation is not approved via the verification of the hotel credit qualification if the booking processing privilege is prohibited.

In one embodiment, this method further includes: 1) forwarding a booking processing privilege setting page of the third-party platform to the client device of the user making the reservation if the booking processing privilege is not set up; and receiving an authorization result of the third-party account returned by the third-party platform; and 2) determining that the user making the reservation is not approved via the verification of the hotel credit qualification if the authorization result is negative.

Step S507: return the verification result of the hotel credit qualification of the user making the reservation to the hotel reservation server.

In one embodiment, after generating a booking of the specified hotel room type for the user making the reservation, the method further comprises: performing a corresponding deduction on the credit score of the third-party account based on the price of the specified room type included in the notification. Correspondingly, after the booking is completed successfully, the method further includes: restoring the credit score for the third-party account accordingly based on the price of the specified room type.

In one embodiment, this method further includes: 1) receiving a resource transfer notification for a hotel booking associated with the booking sent by the hotel reservation server; and 2) transferring resources to the hotel from the third-party account based on the resource transfer notification and the booking. In one embodiment, a transfer success message is sent to the hotel reservation server if the transfer is successful.

A booking management method is provided in the above embodiment. Accordingly, the disclosure further provides a booking management apparatus. The apparatus corresponds to the embodiment of the method embodiments described above.

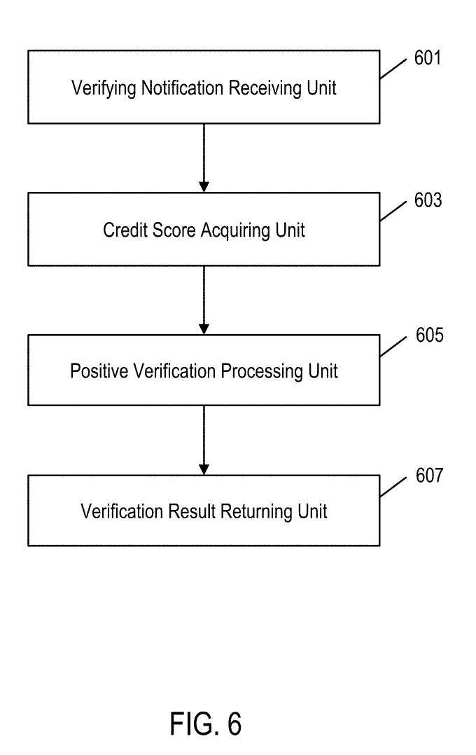

FIG. 6 is a block diagram illustrating a booking management apparatus according to some embodiments of the disclosure. The apparatus embodiment in FIG. 6 is substantially similar to the method embodiments described in connection with FIG. 5 and other figures, therefore, the description is relatively concise. Reference can be made for the relevant parts by referring to some description of the method embodiments described in FIG. 5.

A booking management apparatus illustrated in FIG. 6 includes the following units.

A verifying notification receiving unit 601, configured to receive a notification, sent by a hotel reservation server, for verifying a hotel credit qualification of a user making a reservation.

A credit score acquiring unit 603, configured to acquire a credit score for a third-party account of the user making the reservation based on identity information of the user included in the notification.

A positive verification processing unit 605, configured to determine that the user making the reservation is approved via the verification of the hotel credit qualification if the credit score meets a preset minimum credit score threshold, and generating a booking of the specified hotel room type for the user making the reservation.

A verification result returning unit 607, configured to return the verification result of the hotel credit qualification of the user making the reservation to the hotel reservation server.

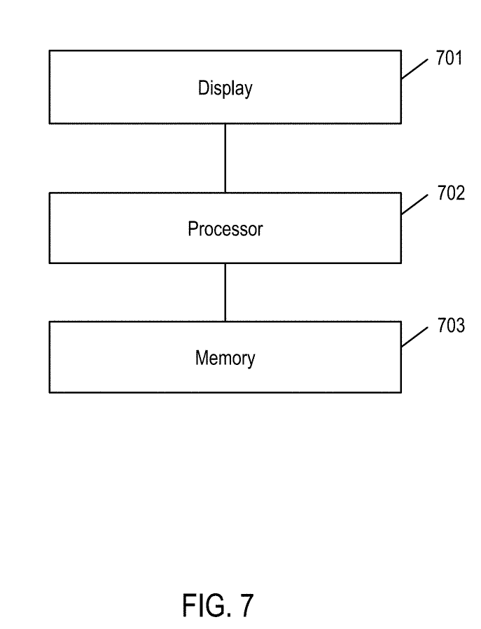

FIG. 7 is a block diagram illustrating an electronic device according to some embodiments of the disclosure. The device embodiment is substantially similar to the method embodiment; therefore, the description is relatively concise. Reference can be made for the relevant parts by referring to some description of the method embodiment. The device embodiment described in the following is merely exemplary.

An electronic device is provided in this embodiment. The electronic device includes: a display 701; a processor 702; and a memory 703. The memory 703 is configured to store a program for implementing a booking management method, and after the device is powered on and runs the program of the booking management method via the processor 702, the following steps are performed: receiving a notification, sent by a hotel reservation server, of verifying a hotel credit qualification of a user making the reservation; acquiring a credit score for a third-party account of the user making the reservation based on identity information of the user making the reservation included in the notification; determining that the user making the reservation is approved via the verification of the hotel credit qualification if the credit score meets a preset minimum credit score threshold; generating a booking of the specified hotel room type for the user making the reservation; and returning the verification result of the hotel credit qualification of the user making the reservation to the hotel reservation server.

A hotel information processing system is provided in the above embodiment. Accordingly, the disclosure further provides a second hotel information processing system as described below.

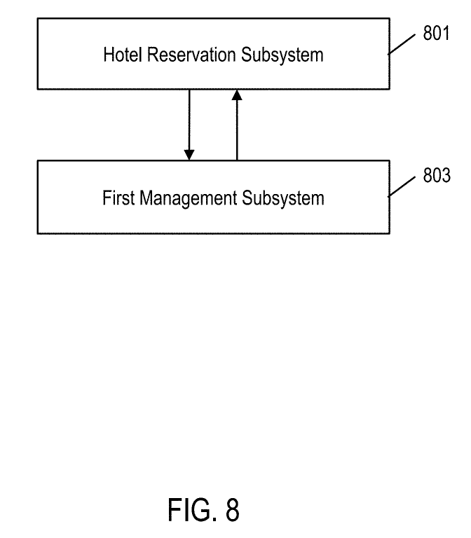

FIG. 8 is a block diagram illustrating a hotel information processing system according to some embodiments of the disclosure. Because the embodiments of the two hotel information processing systems illustrated in FIGS. 1 and 8 are similar, the description here is relatively concise. Reference can be made for the relevant parts by referring to some description of the system embodiment discussed previously in connection with FIG. 1.

The second hotel information processing system of this embodiment includes: a hotel reservation subsystem 801 and a first management subsystem 803.

The hotel reservation subsystem 801 is configured to receive a reservation request for a specified room type sent by a client device of a user; send a notification to verify a hotel credit qualification of the user to the first management subsystem 803 based on the reservation request; receive a verification result of the hotel credit qualification of the user returned by the first management subsystem 803; and generate a first booking of the specified room type for the user based on the reservation request if the verification result of the hotel credit qualification is positive.

The first management subsystem 803 is configured to receive the notification sent by the hotel reservation subsystem 801; acquire a credit score for a third-party account of the user based on identity information of the user included in the notification; determine that the user is approved via the verification of the hotel credit qualification if the credit score meets a preset minimum credit score threshold, and generate a second booking of the specified hotel room type for the user, the second booking being used as a credential by the first management subsystem 803 for managing resource transfer for the first booking; return the verification result of the hotel credit qualification of the user to the hotel reservation subsystem 801.

A difference between the hotel information processing system provided in FIG. 8 and the hotel information processing system provided in FIG. 1 lies in the following: the system in FIG. 8 focuses on the function of the first management subsystem 803, which is for verifying the hotel credit qualification of the user as well as focusing on processes of generating the first booking and the second booking, not defining the process of resource transfer.

With the hotel information processing system provided in FIG. 8, a credit guarantee for a user's spending behavior is provided via the third-party account of the user, which ensures that the spending behavior thereof will be within the limit. When the third-party account of the user meets the requirement of the hotel credit qualification, the user can directly make a hotel reservation, check-in, and make payments without the need of prepaying a deposit. The hotel staying experience of the user may therefore be effectively improved.

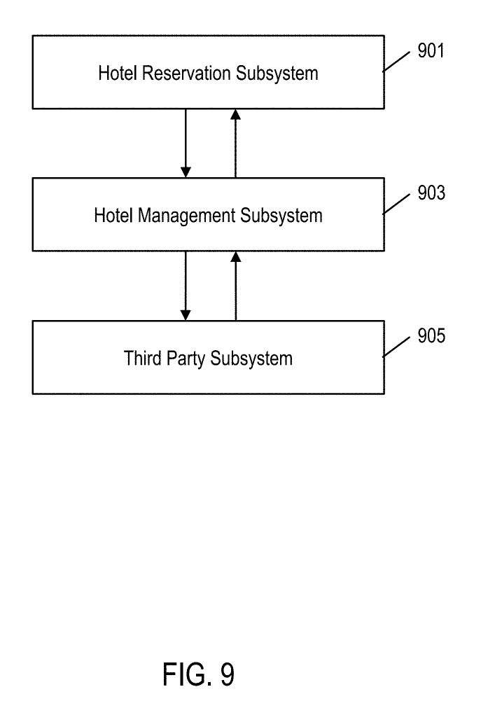

A hotel information processing system is provided in the above embodiment. Accordingly, the disclosure further provides a third hotel information processing system in FIG. 9.

FIG. 9 is a block diagram illustrating a hotel information processing system according to some embodiments of the disclosure. Because the embodiments of the systems are similar, the description here is relatively concise. Reference can be made for the relevant parts by referring to some description of the system embodiments above.

A hotel information processing system illustrated in FIG. 9 includes: a hotel reservation subsystem 901, a hotel management subsystem 903, and a third-party subsystem 905.

The hotel reservation subsystem 901 is configured to receive a reservation request for a specified hotel and a specified room type sent by a client device of a user; acquire a credit score for a third-party account of the user based on identity information of the user included in the reservation request; generate a first booking of the specified room type of the specified hotel for the user if the credit score meets a preset minimum credit score threshold; and send a first notification of a second booking generated in accordance with the first booking to the hotel management subsystem 903; the first booking being used as a credential for managing resource transfer for the second booking by the hotel reservation subsystem 901; receive a second notification, sent by the hotel management subsystem 903, of transferring resources for the second booking; and send to the third-party subsystem a third notification to transfer resources for the first booking based on the second notification.

A difference between the hotel information processing system illustrated in FIG. 9 and the hotel information processing system depicted in FIG. 1 lies in the following: an online hotel reservation function is provided by an official website of the hotel in the first system whereas an online hotel reservation function is provided by a third-party website (e.g. an OTA website) in the third system.

In one embodiment, the client device of the user comprises a mobile communication device such as a smart phone, and may also comprise a terminal device such as a personal computer, a PDA, or a table (e.g., an IPAD).

The hotel reservation subsystem 901 implements an online hotel reservation function, and is generally deployed at a server of an OTA website. However, it is not limited to be deployed at the server of the OTA website; any device that can execute the hotel reservation subsystem 901 described herein can be used.

Another difference between the hotel information processing system illustrated in FIG. 9 and the hotel information processing system of FIG. 1 lies in the following: after generating the first booking, the hotel reservation subsystem 901 of the system needs to send a first notification of generating a second booking corresponding to the first booking to the hotel management subsystem 903, which facilitates the hotel in processing the check-in and payment of the user making the reservation according to the second booking. The second booking of the third system is the same as the first booking of the first system; they are both stored in the hotel reservation server, and are also referred to as a hotel booking. Correspondingly, the first booking of the third system is the same as the second booking of the system illustrated in FIG. 1.

The hotel management subsystem 903 is configured to receive the first notification sent by the hotel reservation subsystem 901; generate the second booking based on the first notification, the second booking being used as a credential for check-in of the user; receive a resource transfer request for the second booking sent by a client device of the specified hotel; and send the second notification to the hotel reservation subsystem 901 based on resource transfer information included in the resource transfer request.

The hotel management subsystem 903 is generally deployed at a server of the hotel; however, it is not limited to be deployed only at that server; and any device that can execute the first management subsystem 903 described herein can be used.

The third-party subsystem 905 is configured to receive the third notification sent by the hotel reservation subsystem 901; remove resources from the third-party account based on the third notification; and transfer the removed resources of the second booking to a third-party account of the specified hotel.

An alternative hotel information processing system is provided in the above embodiments described in connection with FIG. 9. Accordingly, the disclosure further provides another hotel reservation method, which runs in the hotel reservation subsystem 901 in the hotel information processing system described in connection with FIG. 9.

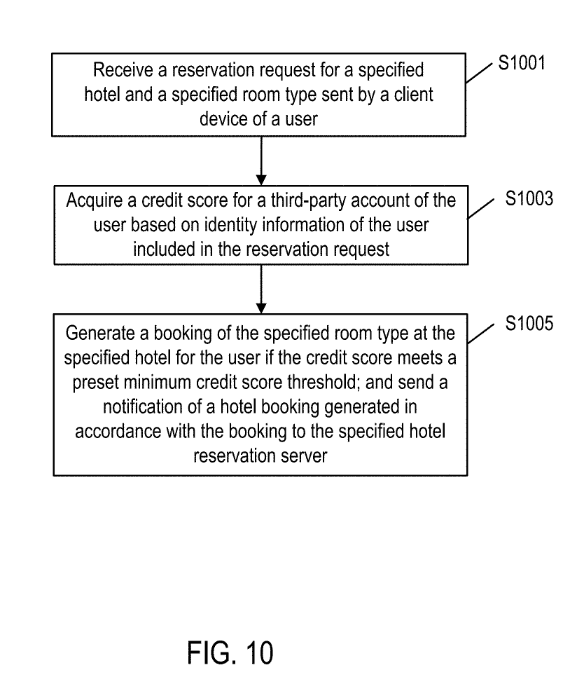

FIG. 10 is a flow diagram illustrating a hotel reservation method according to some embodiments of the disclosure. The method embodiment is substantially similar to the system embodiment discussed in connection with FIG. 9; therefore, the description is relatively concise. Reference can be made for the relevant parts by referring to some description of the system embodiment of FIG. 9.

An alternative hotel reservation method of includes the following steps.

Step S1001: receive a reservation request for a specified hotel and a specified room type sent by a client device of a user.

Step S1003: acquire a credit score for a third-party account of the user based on identity information of the user included in the reservation request.

Step S1005: generate a booking of the specified room type at the specified hotel for the user if the credit score meets a preset minimum credit score threshold; and send a notification of a hotel booking generated in accordance with the booking to the specified hotel reservation server.

In one embodiment, the method further includes the following steps: 1) receiving a resource transfer notification for the hotel booking sent by the server of the specified hotel; and 2) transferring resources to the specified hotel from the third-party account based on the resource transfer notification and the booking.

An alternative hotel reservation method is provided in the above embodiments. Accordingly, the disclosure further provides another hotel reservation apparatus. The apparatus corresponds to the embodiment of the method embodiment above.

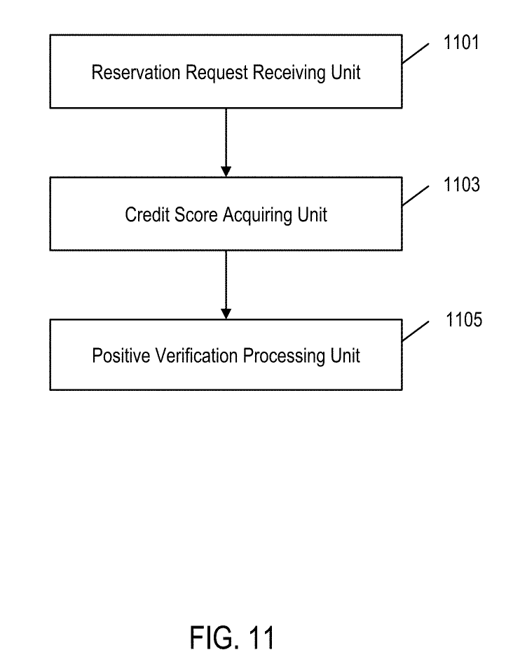

FIG. 11 is a block diagram illustrating a hotel reservation apparatus according to some embodiments of the disclosure. The apparatus embodiment is substantially similar to the method embodiment described in connection with FIG. 10, therefore, the description is relatively concise. Reference can be made for the relevant parts by referring to some description of the method embodiment described in connection with FIG. 10.

An alternative hotel reservation apparatus illustrate in FIG. 10 includes the following units.

A reservation request receiving unit 1101, configured to receive a reservation request for a specified hotel and a specified room type sent by a client device of a user.

A credit score acquiring unit 1103, configured to acquire a credit score for a third-party account of the user based on identity information of the user included in the reservation request.

A positive verification processing unit 1105, configured to generate a booking of the specified room type at the specified hotel for the user if the credit score meets a preset minimum credit score threshold; and sending a notification of a hotel booking generated in accordance with the booking to the specified hotel reservation server.

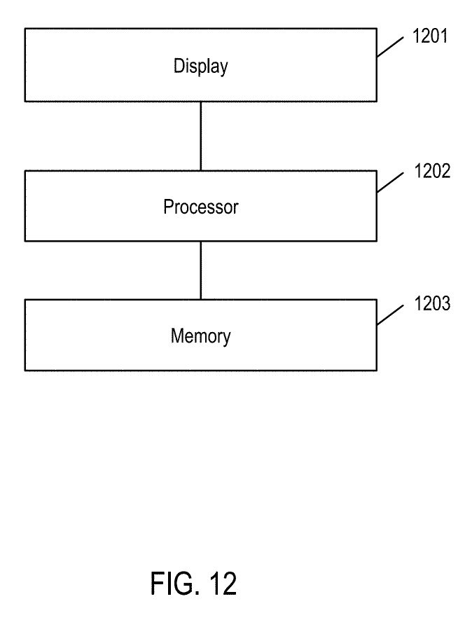

FIG. 12 is a block diagram illustrating an electronic device according to some embodiments of the disclosure. The device embodiment in FIG. 12 performs operations substantially similar to the method embodiments discussed in connection with FIG. 10, therefore, the description is relatively concise. Reference can be made for relevant parts by referring to the description of the method embodiment described in connection with FIG. 10.

An electronic device is provided FIG. 12. The electronic device includes: a display 1201; a processor 1202; and a memory 1203. The memory 1203 is configured to store a program for implementing a hotel reservation process, and after the device is powered on and runs the program of the hotel reservation method via the processor 1202, the following steps are performed: receiving a reservation request for a specified hotel and a specified room type sent by a client device of a user; acquiring a credit score for a third-party account of the user based on identity information of the user included in the reservation request; generating a booking of the specified room type at the specified hotel if the credit score meets a preset minimum credit score threshold; and sending a notification of a hotel booking generated in accordance with the booking to the specified hotel reservation server.

In accordance with the hotel information processing system discussed in connection with FIG. 9, the disclosure further provides a booking generation method, which runs in the hotel management subsystem 903 in the hotel information processing system discussed in connection with FIG. 9.

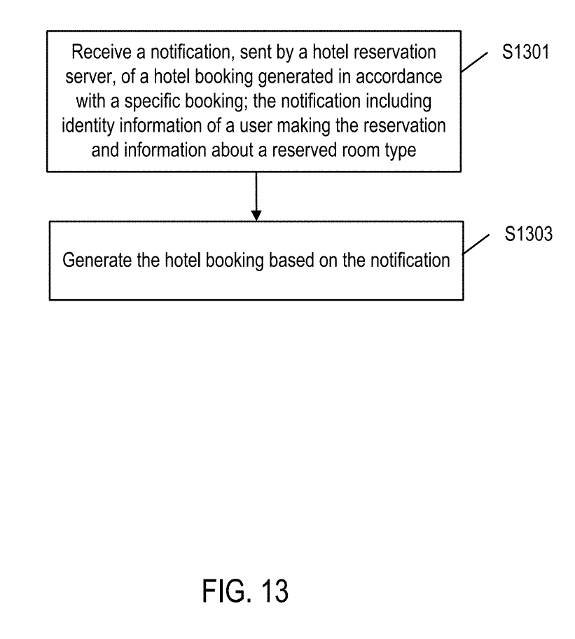

FIG. 13 is a flow diagram illustrating a booking generation method according to some embodiments of the disclosure. Descriptions of various steps in the embodiment illustrated in FIG. 13 are similar to those of the embodiment illustrated in FIG. 2, the disclosure of which is not repeated herein. Reference may be made by referring to the corresponding parts of the embodiments described in connection with FIG. 2. A booking generation method provided in the illustrated embodiment of FIG. 13 includes the following steps.

Step S1301: receive a notification, sent by a hotel reservation server, of a hotel booking generated in accordance with a specific booking; the notification including identity information of a user making the reservation and information about a reserved room type.

Step S1303: generate the hotel booking based on the notification.

In one embodiment, the illustrated method further includes the following steps: 1) receiving a resource transfer request for the hotel booking sent by a client device of a hotel; and 2) sending a notification, to the hotel reservation server, of transferring resources for the hotel booking based on resource transfer information included in the resource transfer request.

A booking generation method is provided in the above embodiment. Accordingly, the disclosure further provides a booking generation apparatus corresponding to the embodiment of the method embodiment illustrated in FIG. 13.

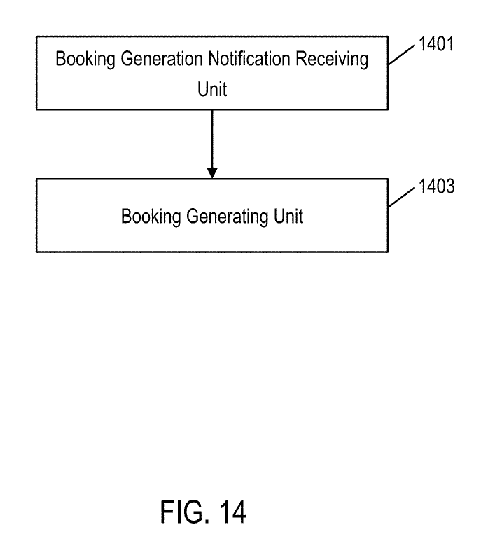

FIG. 14 is a block diagram illustrating a booking generation apparatus according to some embodiments of the disclosure. The embodiment illustrated in FIG. 14 performs operations similar to the method embodiment described in connection with FIG. 13, therefore, the description is relatively concise. Reference can be made for relevant parts by referring to the description of the method embodiments of FIG. 13.

The booking generation apparatus in FIG. 14 includes the following units.

A booking generation notification receiving unit 1401, configured to receive a notification, sent by a hotel reservation server, of a hotel booking generated in accordance with a specific booking; the notification including identity information of a user making the reservation and information about a reserved room type.

A booking generating unit 1403, configured to generate the hotel booking based on the notification.

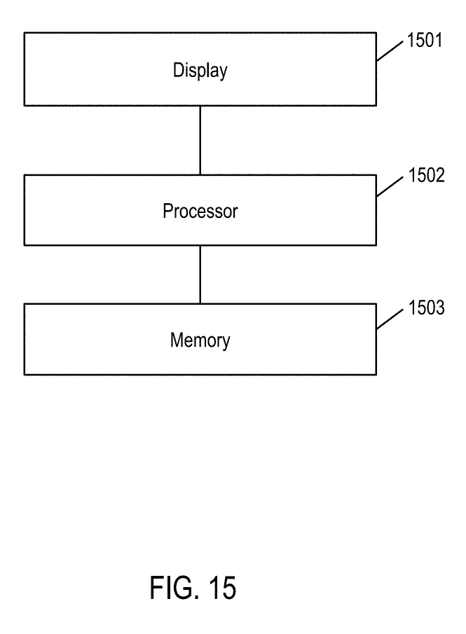

FIG. 15 is a block diagram illustrating an electronic device according to some embodiments of the disclosure. The device embodiment illustrated in FIG. 15 performs operations similar to the method embodiment described in connection with FIG. 13, therefore, the description is relatively concise. Reference can be made for the relevant parts by referring to the description of the method embodiment described in connection with FIG. 13.

An electronic device is provided in the embodiment illustrated in FIG. 15. The electronic device includes: a display 1501; a processor 1502; and a memory 1503. The memory 1503 is configured to store a program for implementing a booking generation method, and after the device is powered on and runs the program of the booking generation method via the processor 1502, the following steps are performed: receiving a notification, sent by a hotel reservation server, of a hotel booking generated in accordance with a specific booking; the notification including identity information of a user making the reservation and information about a reserved room type; and generating the hotel booking based on the notification.

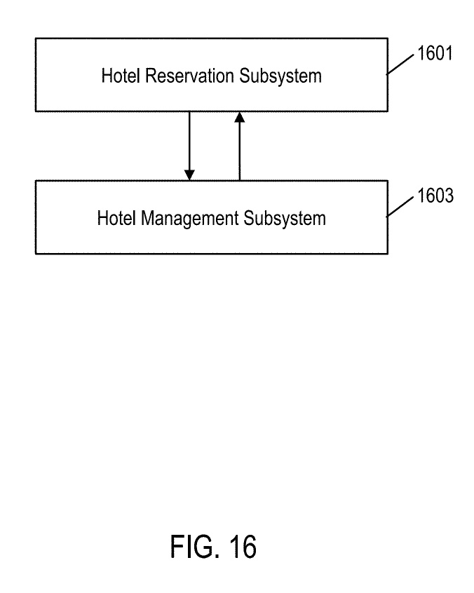

FIG. 16 is a block diagram illustrating a hotel information processing system according to some embodiments of the disclosure. Because the embodiments of the two systems discussed previously are similar, the description here is relatively concise. Reference can be made for the relevant parts by referring to some description of the system embodiments described previously.

The hotel information processing system illustrated in FIG. 16 includes: a hotel reservation subsystem 1601 and a hotel management subsystem 1603.

The hotel reservation subsystem 1601 is configured to receive a reservation request for a specified hotel and a specified room type sent by a client device of a user; acquire a credit score for a third-party account of the user based on identity information of the user included in the reservation request; generate a first booking of the specified room type at the specified hotel for the user if the credit score meets a preset minimum credit score threshold; and send a first notification of a second booking generated in accordance with the first booking to the hotel management subsystem; the first booking being used as a credential for managing resource transfer for the second booking by the hotel reservation subsystem 1601.

The hotel management subsystem 1603 is configured to receive the notification sent by the hotel reservation subsystem 1601; and generate the second booking based on the notification, the second booking being used as a credential for check-in of the user.

A difference between the hotel information processing system illustrated in FIG. 16 and the hotel information processing system illustrated in FIG. 9 lies in the following: the system in FIG. 16 focuses on the function of the hotel reservation subsystem 1601, which is for verifying the hotel credit qualification of the user as well as focusing on processes of generating the first booking and the second booking, not defining the process of resource transfer.

With the hotel information processing system provided in FIG. 16, a credit guarantee for a user's spending behavior is provided via the third-party account of the user, which ensures that the spending behavior thereof will be within the limit. When the third-party account of the user meets the requirement of the hotel credit qualification, the user can directly make a hotel reservation, check-in, and make payments without the need of prepaying a deposit. The hotel staying experience of the user may therefore be effectively improved.

The disclosure is provided above with particular embodiments; however, the embodiments are not intended to limit the disclosure. Any person skilled in the art can make variations and modifications without departing from the spirit and scope of the disclosed embodiments. Therefore, the scope of the disclosed embodiments should be subject to the scope defined by claims of the disclosure.

In a typical configuration, a computing device includes one or more processors (CPUs), an input/output interface, a network interface and a memory.

The memory may include a computer readable medium in the form of a non-permanent memory, a random-access memory (RAM) and/or a non-volatile memory or the like, such as a read-only memory (ROM) or a flash memory (flash RAM). The memory is an example of a computer readable medium.

The computer readable medium includes permanent and non-permanent, movable and non-movable media that can achieve information storage by means of any methods or techniques. The information may be computer readable instructions, data structures, modules of programs or other data. Examples of the storage medium of the computer include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disk (DVD) or other optical storages, magnetic cassette, magnetic tape, magnetic disk storage or other magnetic storage devices, or any other non-transmission medium that can be used for storing information accessible by a computing device. In light of the definitions herein, the computer readable medium does not include non-transitory computer readable media (transitory media), such as modulated data signals and carrier waves.

It should be understood by those skilled in the art that the disclosed embodiments may be provided as a method, a system, or a computer program product. Thus, the disclosed embodiments may employ the form of a fully hardware embodiment, a fully software embodiment, or an embodiment combining software and hardware elements. Moreover, the disclosed embodiments may employ the form of a computer program product implemented on one or more computer usable storage media (including but not limited to a magnetic disk memory, CD-ROM, an optical memory, etc.) containing computer usable program code therein.

What is claimed is:

1. A method comprising:
receiving, at a processing device, a notification sent by a hotel reservation server for verifying a hotel credit qualification of a user submitting a reservation request, the notification including identity information associated with the user;
acquiring, by the processing device, a credit score for a third-party account of the user based on the identity information;
determining, by the processing device, that the user is approved for the hotel credit qualification if the credit score meets a preset minimum credit score threshold;
generating, by the processing device, a booking for the user of a specified hotel room type included within the reservation request; and
returning, by the processing device, a verification result of the hotel credit qualification of the user to the hotel reservation server.

2. The method of claim 1, wherein acquiring a credit score for a third-party account of the user based on the identity information comprises:
sending, by the processing device, a credit score query request for the third-party account to a third-party platform; and
receiving, at the processing device, the credit score for the third-party account from the third-party platform.

3. The method of claim 2, wherein prior to generating a booking for the user of a specified hotel room type included within the reservation request, the method further comprises:
forwarding, by the processing device to a client device of the user, a password verification page of the third-party platform, wherein the third-party platform verifies a password of the third-party account based on a password of the third-party account provided by the user via the password verification page;
receiving, at the processing device, a password verification result of the password of the third-party account from the third-party platform; and
determining, by the processing device, that the user is not approved for the hotel credit qualification if the password verification result is negative.

4. The method of claim 1, wherein prior to the generating a booking for the user of a specified hotel room type included within the reservation request, the method further comprises:
sending, by the processing device, a booking processing privilege query request for the third-party account to a third-party platform;
receiving, at the processing device, a booking processing privilege of the third-party account returned by the third-party platform; and
determining, by the processing device, that the user is not approved for the hotel credit qualification if the booking processing privilege is prohibited by the third-party platform.

5. The method of claim 1, further comprising:
forwarding, by the processing device, a booking processing privilege setting page of a third-party platform to a client device of the user if a booking processing privilege is not set up;
receiving, at the processing device, an authorization result of the third-party account returned by the third-party platform; and
determining, by the processing device, that the user is not approved for the hotel credit qualification if the authorization result is negative.

6. The method of claim 1, wherein after a notification sent by a hotel reservation server for verifying a hotel credit qualification of a user submitting a reservation request, the method further comprises:
setting, by the processing device, the minimum credit score threshold based on a price of the specified hotel room type included in the notification.

7. The method of claim 6, wherein the credit score for the third-party account is generated by generating the credit score for the third-party account based on personal information of the user.

8. The method of claim 1, wherein after generating a booking for the user of a specified hotel room type included within the reservation request, the method further comprises:
performing, by the processing device, a corresponding deduction on the credit score of the third-party account based on the price of the specified hotel room type included in the notification; and
after the booking is placed successfully, the method further comprises:
restoring, by the processing device, the credit score for the third-party account accordingly based on the price of the specified hotel room type.

9. The method of claim 1, further comprising:
receiving, by the processing device, a resource transfer notification for a hotel room reservation associated with the booking sent by the hotel reservation server; and
transferring, by the processing device, resources to the hotel from the third-party account based on the resource transfer notification and the booking.

10. The method of claim 9, further comprising:
sending, by the processing device, a transfer success message to the hotel reservation server if the resource transfer is successful.

11. An apparatus comprising:
a processor; and
a non-transitory memory storing computer-executable instructions therein that, when executed by the processor, cause the apparatus to perform the operations of:
receiving a notification sent by a hotel reservation server for verifying a hotel credit qualification of a user submitting a reservation request, the notification including identity information associated with the user;
acquiring a credit score for a third-party account of the user based on the identity information;
determining that the user is approved for the hotel credit qualification if the credit score meets a preset minimum credit score threshold;
generating a booking for the user of a specified hotel room type included within the reservation request; and
returning a verification result of the hotel credit qualification of the user to the hotel reservation server.

12. The apparatus of claim 11, wherein acquiring a credit score for a third-party account of the user based on the identity information comprises:
sending a credit score query request for the third-party account to a third-party platform; and
receiving the credit score for the third-party account from the third-party platform.

13. The apparatus of claim 12, wherein prior to generating a booking for the user of a specified hotel room type included within the reservation request, the operations further include:
forwarding, to a client device of the user, a password verification page of the third-party platform, wherein the third-party platform verifies a password of the third-party account based on a password of the third-party account provided by the user via the password verification page;
receiving a password verification result of the password of the third-party account from the third-party platform; and
determining that the user is not approved for the hotel credit qualification if the password verification result is negative.

14. The apparatus of claim 11, wherein prior to the generating a booking for the user of a specified hotel room type included within the reservation request, the operations further include:
sending a booking processing privilege query request for the third-party account to a third-party platform;
receiving a booking processing privilege of the third-party account returned by the third-party platform; and
determining that the user is not approved via the verification of the hotel credit qualification if the booking processing privilege is prohibited by the third-party platform.

15. The apparatus of claim 11, wherein the operations further include:
forwarding a booking processing privilege setting page of a third-party platform to a client device of the user if a booking processing privilege is not set up;
receiving an authorization result of the third-party account returned by the third-party platform; and
determining that the user is not approved for the hotel credit qualification if the authorization result is negative.

16. The apparatus of claim 11, wherein after a notification sent by a hotel reservation server for verifying a hotel credit qualification of a user submitting a reservation request, the operations further include:
setting the minimum credit score threshold based on a price of the specified hotel room type included in the notification.

17. The apparatus of claim 16, wherein the credit score for the third-party account is generated by generating the credit score for the third-party account based on personal information of the user.

18. The apparatus of claim 11, wherein after generating a booking for the user of a specified hotel room type included within the reservation request, the operations further include:
performing a corresponding deduction on the credit score of the third-party account based on the price of the specified hotel room type included in the notification; and
after the booking is placed successfully, the operations further include:
restoring the credit score for the third-party account accordingly based on the price of the specified hotel room type.

19. The apparatus of claim 11, wherein the operations further include:
receiving a resource transfer notification for a hotel room reservation associated with the booking sent by the hotel reservation server; and
transferring resources to the hotel from the third-party account based on the resource transfer notification and the booking.

20. The apparatus of claim 19, wherein the operations further include:
sending a transfer success message to the hotel reservation server if the resource transfer is successful.
